(19) United States
(12) Patent Application Publication
(10) Pub. No.: US 2018/0174088 A1
(43) Pub. Date: Jun. 21, 2018

(54) Systems and Methods for Artificial Intelligence-Based Gamified Retail Sales Accelerator

(71) Applicant: Dennis Eugene Brown, Newport Beach, CA (US)

(72) Inventor: Dennis Eugene Brown, Newport Beach, CA (US)

(21) Appl. No.: 15/379,790

(22) Filed: Dec. 15, 2016

(51) Int. Cl. G06Q 10/06; G06N 99/00; G06Q 30/06

(52) U.S. Cl. CPC G06Q 10/06393; G06Q 30/0631; G06N 99/005

(57) ABSTRACT

A system, method and user interface are described for providing retail salesperson(s) with a sales acceleration system using a mobile computing device, a gamification system, an integration engine that provides access to existing corporate data, media resources communications facilities and management structures and a learning machine that selects products to offer customers based on spend profile, multichannel sales interest, inventory and emotional state to allow salesperson(s) to individualize customer product offerings with the highest predictive probability score for purchase. Notable feature of Invention is the ability to engage salesperson(s) through a game that awards points for each activity completion. Management configures game steps for the enterprise as a whole or for any business unit, department, time of day or any other available criteria in a matrix and weights step completion values according to objectives of area, unit, store or enterprise.

### FIELD AND BACKGROUND OF INVENTION

### Field of Invention

The present invention is in the field of artificial intelligence-based electronic personal assistant(s) using adaptive intelligence and machine learning to identify the shoppers' emotional state, discern which activities have taken place, suggest tasks to be performed, and select product offering(s) based on likelihood of profitable purchase.

### Background of Invention

The present invention provides systems and methods that leverage enterprise Business Intelligence systems to enable mobile-equipped user to access all relevant multi-channel data resources, collect proprietary customer activity data stream, evaluate shopper's' preferences, and make real-time recommendations to shoppers to achieve the highest probability of profitable transactions for enterprise.

The present invention relates to resourcing retail salesperson(s) as knowledge worker(s) with mobile Wi-Fi or other communication protocol-connected device(s) to access enterprise data resources, make intelligent recommendations and deliver higher levels of customer service and engagement in repetitive tasks

Legacy sales improvement schemes generally exhibit short-term and limited effectiveness in raising salesperson(s)' professionalism, engagement or service levels.

On-boarding orientation and periodic sales training conducted by enterprise, stores or by vendors suffer from human inertia. Salesperson(s) tend to revert to prior patterns, actions and inactions.

Sales contests are a technique employed by retail enterprises to try to improve salesperson(s) productivity. But ability of management to overcome human inertia using sales contests is limited in the short-term, and non-existent in the long term. Historically, high performers outperform their peers during sales contests; while middle-performers and low-performers become frustrated and lose engagement. Many successive sales contests are counter-productive to enterprise profitability over time.

Reengineering sales processes to diminish salesperson(s)' hours is an enterprise strategy that may reduce costs in the short-term, but generally leads to elevated staff turnover and customer dissatisfaction.

Sales managers are tasked with maximizing salesperson(s) productivity in order to increase enterprise revenues, margins, and profits. Sales managers spend substantial time reviewing point-of-sales graphs and data to evaluate salesperson(s) performance.

It is unproductive for sales managers to constantly surveil salesperson(s), because salesperson(s) behave differently when they know management is watching. No application currently exists today that can provide continuous real-time tracking of salesperson(s)' activities, recommendations, conversion ratios and performance metrics.

Enterprises can achieve higher salesperson(s) productivity by collecting salesperson(s) activity completions, patterns, and trends and using that data to manage, coach and counsel individual salesperson(s) based on their comparative performance.

But enterprises lack the disaggregated salesperson(s) results, or even activity by individual, time of day, manager, store, region and product area that are necessary to support salesperson(s) performance monitoring, sales manager coaching, and profit improvement.

Enterprise management generally agree that customers crave a more personalized experience with shopping and purchasing tailored to their own desires, needs, wants and resources. Providing such an experience while boosting profitability has emerged as the central retail sales management challenge.

Retailer enterprises have invested substantial financial resources on big data intelligence initiatives to analyze customer behavior, build customer profiles, understand which products are likely to appeal to which customers, and what product purchases foretell about customer preferences and future purchases. But retail salesperson(s), who represent the enterprise at the point of decision, have limited access to enterprise Business Intelligence data, product data or other knowledge-based resources. As non-knowledge-workers, retail salesperson(s) tend to be lower-paid, less-trained, under-resourced, under-managed and subject to high turnover rates.

Retailing features an extensive and constantly-changing set of business factors and circumstances that govern which products salesperson(s) should display, highlight and recommend to create the highest probability of a profitable interaction.

These factors have been analyzed and optimized at the corporate level to improve enterprise performance, presentation and recommendations on the store's website. Most retail websites have at least a rudimentary product recommendation strategy.

These factors and the resulting recommendations are seldom available in real-time to the enterprise's retail salesperson(s), where they would serve to achieve optimal customer satisfaction, transactions and profitability.

Customers become frustrated when products they wish to purchase are out of stock or otherwise unavailable. Although salesperson(s) may have some visibility on the product stocking levels, most have no mobile access to inventory and fulfillment data.

Customer survey data indicates retail customers have an elevated probability after first purchase to making a second, third and even fourth purchases in a single session, due to lowered mental barriers to purchase.

With no readily available resource to track recent customer purchases or preference data, salesperson(s) have limited real-time guidance to leverage customer's lowered mental barrier to further transactions. RSI research data indicate that salesperson(s) suggest additional items for purchase less than 20% of the time.

Enterprise merchandisers generally have access to substantial data resources for analyzing and describing patterns and trends associated with customer transactions. Their retail point-of-sale systems capture and their backend systems correlate customer transactions with information about customers' demographic profile, social media activity, and other communications.

But data regarding retail customers' in-store behavior is limited. Retailers do not capture how shoppers initially describe their interests; what products caught shoppers' eye at the store level; how customers described their interests and preferences; and what was their receptivity to salesperson(s)'s suggestions.

Although these are crucial data points, almost no comprehensive data collection regarding customers' in-store shopping experience exists. Extending big data collection to the salesperson(s) creates significant competitive advantage for enterprise.

Sales of multi-item ensembles, kits, outfits or other business Intelligence-driven groupings of products can drive higher levels of customer satisfaction and higher levels of salesperson(s) productivity, generating more transactions, expanded profit expansion and higher levels of customer satisfaction. These offerings are almost never provided at the salesperson(s) level.

Brands make substantial resource investments to create and deliver their images and messaging to target audiences in expectation of driving product awareness, brand loyalty and higher numbers of transactions. Brands tend to have limited ability to maximize the effectiveness of these investments at the point of decision with shopper(s).

Brands currently capture almost no data regarding the retail customer actions or inactions prior to the actual product selection and purchase. Relying on non-knowledge workers with no automated or organized data collection capabilities, undermines sales-effectiveness of brand marketing and messaging.

Brands generally invest resources in promotional testimonials, reviews, videos and photographs for each of their individual products. Currently, there is limited ability to deliver these resources to the interested shopper at the point of decision.

Over ⅔ of retail customers in 2015 did some research online prior to making a purchase decision. Customers generally enter a retail store with more knowledge about the products and pricing than the salesperson(s) who are tasked with serving them.

Only a low percentage of shoppers say that they enter a store looking to rely on retail salesperson(s) to provide information and guidance.

Customers have been said to engage in showrooming (i.e. using retail venues as showrooms to discover and test products to purchase online).

Most salesperson(s) generally lack real-time comparative data for prices, alternatives, ratings, and ensembles that would enable profitable sales, upsells and add-on sales. Salesperson(s) generally lack access to brand resources at the point of customer decision, where they would increase probability of profitable transactions.

Retail enterprises often sponsor loyalty programs to increase connection with customers. Such programs enable enterprises to connect demographic profile data with multichannel purchases in the Internet channel or in the physical channel only after the shopping journey has been completed. Retail salesperson(s) serving customers have almost no resources to support similar judgments.

Inability to improve salesperson(s) productivity, explains why enterprise stores have generally cut expenditures and investments in salesperson(s). But Retail Sciences' research indicates one of the top two drivers that customers do value is human interaction with salesperson(s). Nearly half of shoppers surveyed say they enter a store looking for guidance and open to suggestions.

Enterprises seldom have continuous salesperson(s) training. Sales managers are expected to act as “coaches” to help salesperson(s) improve performance. But effective coaching requires consistent, ongoing, detailed and relevant interactions to improve salesperson(s) productivity.

Without making the sales managers into knowledge workerw, without providing managers real-time visibility on salesperson(s)' and shoppers' activities, such coaching as does occur has limited relevance and limited effectiveness in generating more transactions and higher profits.

### BRIEF DESCRIPTION OF FIGURES

FIG. 1: exemplary schematic overview of the relationships of various components of Invention, including shopper, salesperson(s), mobile devices, processors and data stores in an exemplary embodiment of the present invention.

FIG. 2: example of a Shopper Identification screen whereby the salesperson(s) enters by means of keyboard or spoken word the shopper's Loyalty Program Identifier, Product Interest Indicator or Checkout Indicator. FIG. 2 also provides immediate access to the shopper's wish list and to the device's barcode reader which will enable capture of shoppers' interests, and drive selection of products to be offered.

FIG. 3: example of a Loyalty data display screen whereby salesperson(s) can view enterprise-selected information (in example, spend profile and recent searches) about instant shopper once shopper has been identified.

FIG. 4: example of a Product Recommendation Screen, wherein salesperson(s) is coached which products to recommend based on shopper's Interest Indicator, spend profile, shopping history, wish list contents, and enterprise revenue and profit considerations. FIG. 4 also illustrates invention's ability to offer ensembles responsive to shopper's interest indicator.

FIG. 5: example of an ensemble offering, enabling salesperson(s) to offer a more robust, convenient and compelling answer to shopper's interest indicator.

FIG. 6: example of an Additional Product Screen, coaching salesperson(s) to offer additional products to shopper once an initial selection has been made.

FIG. 7: shopping process flow chart showing how salesperson(s) is coached to offer optimized display of initial and additional products to maximize shopper satisfaction and enterprise profitability.

FIG. 8: block diagram of example game wherein invention coaches salesperson(s) to perform a task and provides resources to accomplish it. Salesperson(s) performs task and then taps icon signaling completion of the task; invention awards points and updates personal scorecard and then coaches salesperson(s) to perform next task.

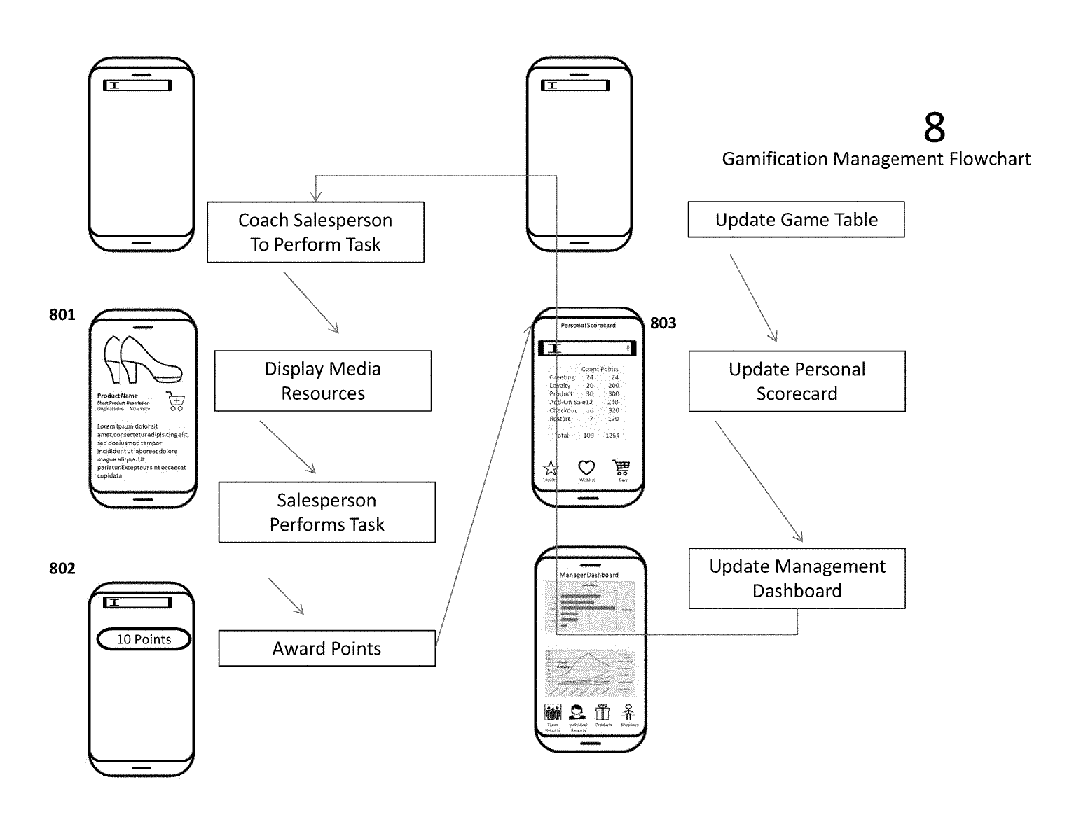

FIG. 9: example checkout screen enabling salesperson(s) to confirm purchase, offer additional products from wish list for purchase, and enable shopper to either carry products home or have them shipped. It also provides access to continuation of the shopping experience update of Loyalty Program data and gateway to additional system functions.

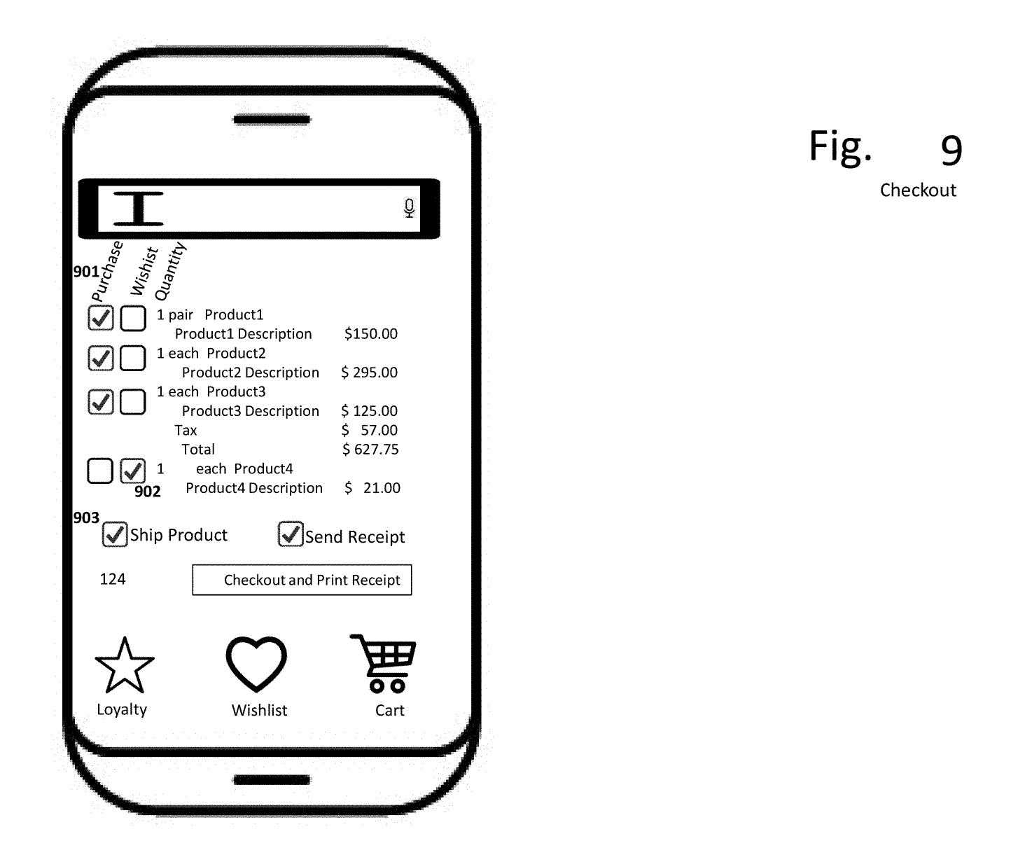

FIG. 10: example game table wherein enterprise, department, store or business unit or sales manager to describe the steps of the game and the points to be awarded for each completion.

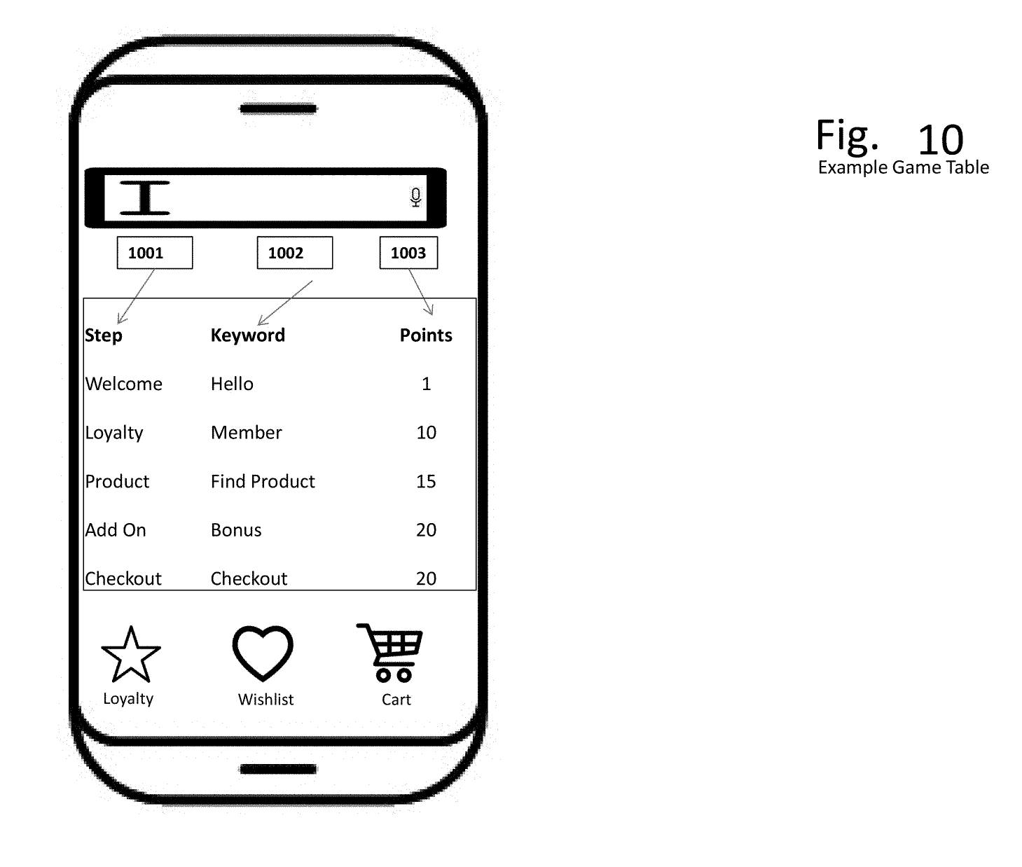

FIG. 11: example gamified competitive ranking (animated) showing instant user's position in comparison with her peers.

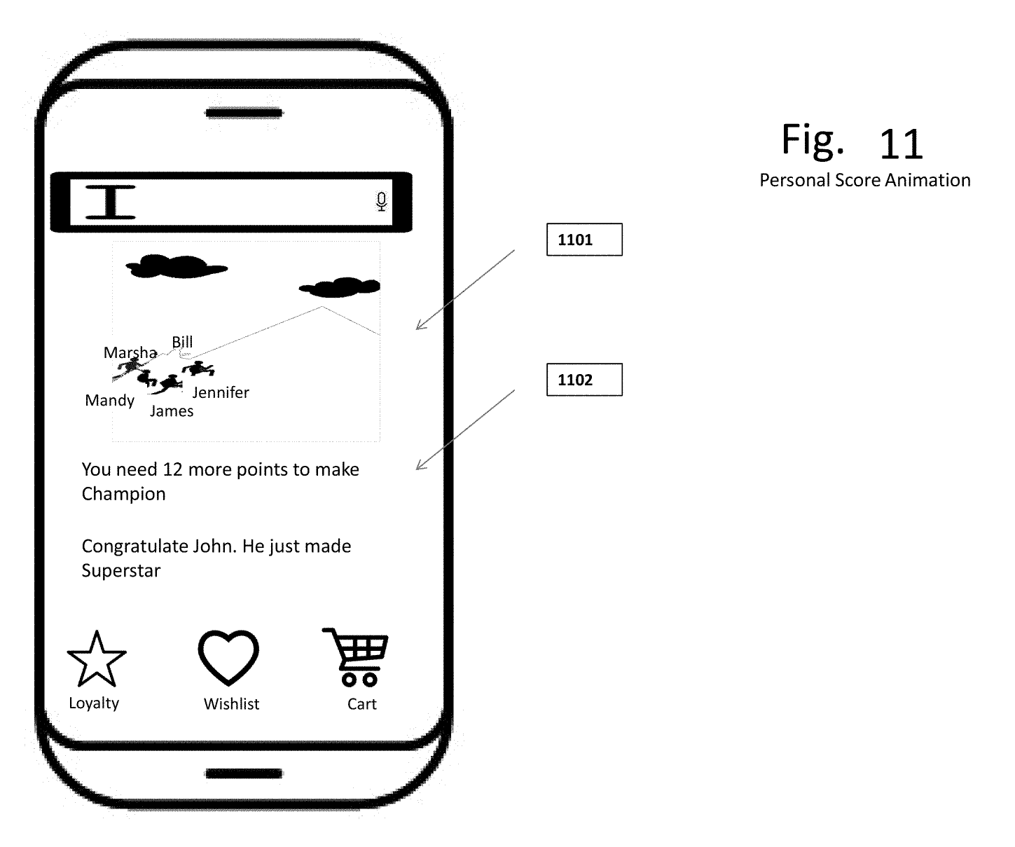

FIG. 12: example personal scorecard showing salesperson(s) his/her completions and points earned.

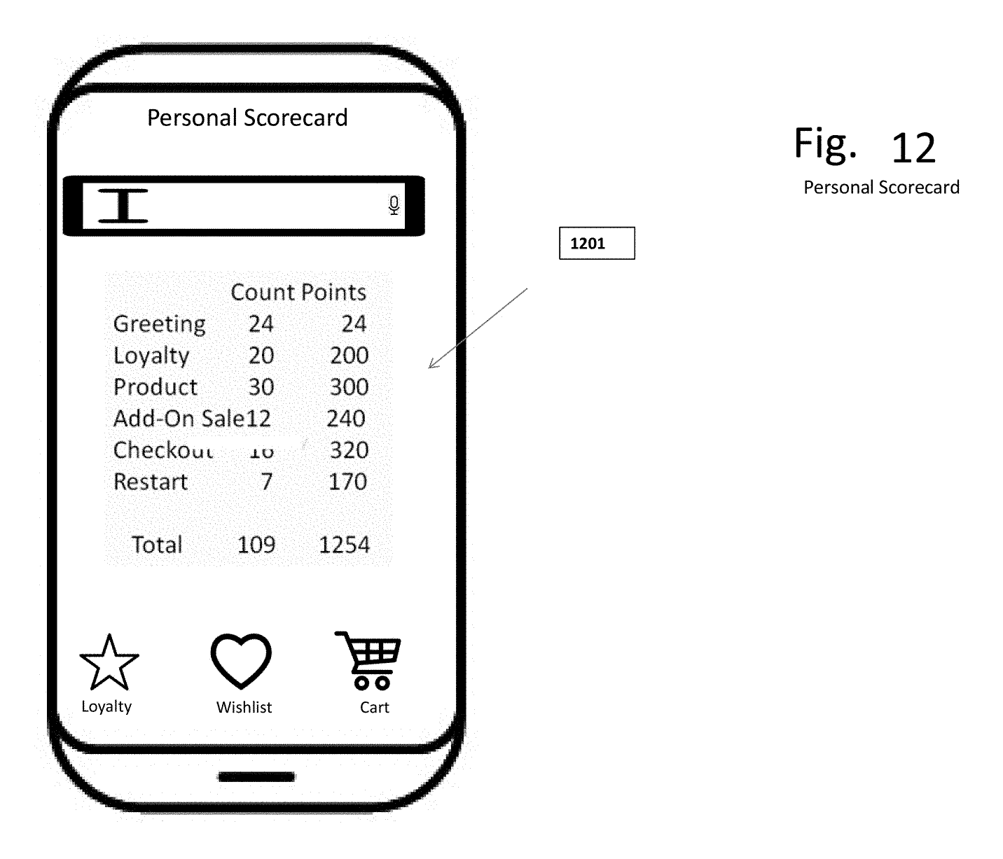

FIG. 13: example manager dashboard showing activity levels and conversion ratios for team members in real time to enable coaching, oversight, praise and correctives as they are needed.

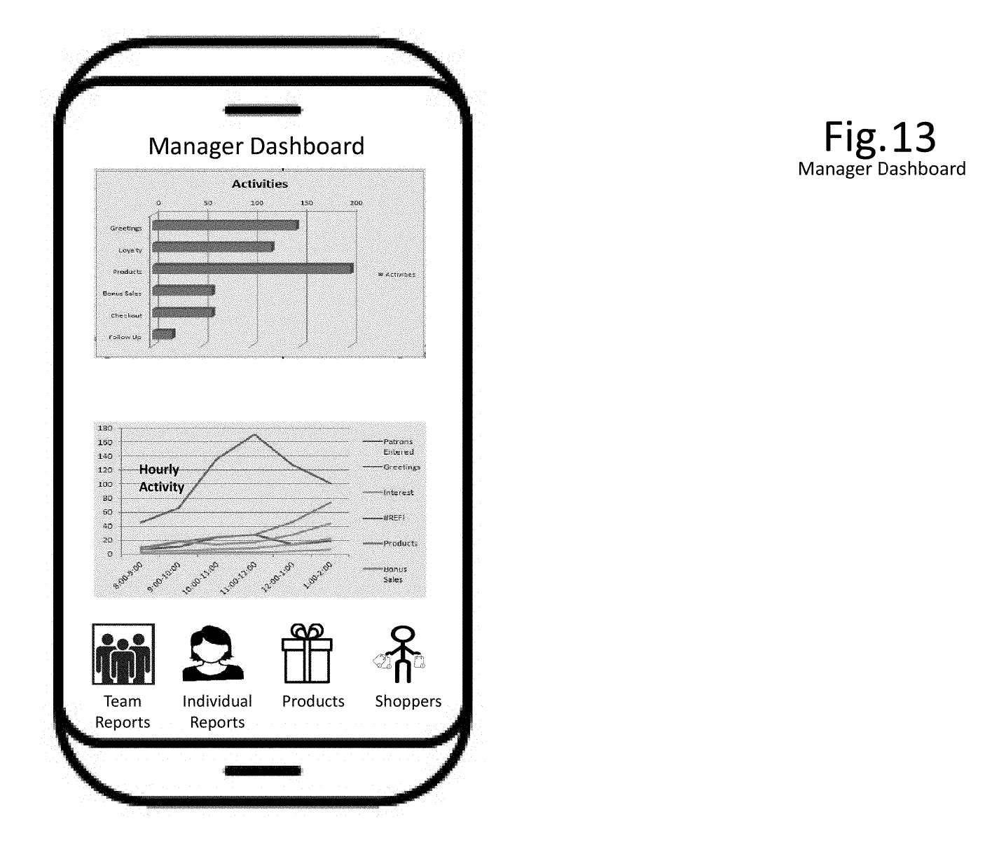

### DESCRIPTION OF INVENTION

### Summary of Invention

a) Invention provides at least one process for conducting a retail sales interaction and a game structure that incentivizes the salesperson(s) to follow the steps, provides coaching and information and media resources according to the needs of the step being taken.

b) Invention provides the salesperson(s) immediate coaching, recognition and rewards for completing each step of the process, and provides a basis for management monitoring, coaching and comparison and competition with other salesperson(s).

c) Invention game structure for the retail sales process enables delivery of a richer set of coaching and product resources to the retail salesperson(s), enabling salesperson(s) to maintain contact with and better serve the shopper, and to sell more products at higher prices. Invention also captures information leading to continuous improvement of sales processes, marketing, merchandising, product support, staffing and training.

d) Invention induces higher levels of staff engagement by providing continuous recognition and rewards, as well as optimized resources for activity completion.

e) Invention provides real-time activity performance data for sales managers to use to identify areas of each person's strengths and weaknesses and enable timely recognition, praise, feedback, coaching and interventions.

f) Invention provides salesperson(s) visibility on salesperson(s)' own activity levels in comparison with those of other salesperson(s).

g) Invention gives shoppers additional opportunity and incentive to join the enterprise's loyalty program.

h) Invention enables management to resource salesperson(s) to make appropriate and successful product recommendations that enhance customer satisfaction, and build additional revenues and margins.

i) Invention enables management to insure that only products actually available will be recommended.

j) Invention collects detailed information abut each shopper's interests, considerations, selections and actions prior to making a purchase.

k) Invention provides merchandising departments with intelligence regarding what products are shown and which are interest-indicated, detailing the steps of each customer's Journey from initial request to ultimate purchase(s).

l) Invention provides single-click access and voice-command-detected access to product information resources so streamlined that salesperson(s)'s attentions are not unduly diverted from the customer to the device.

m) Invention's Learning Machine utilizes the Business Intelligence resources of the enterprise to influence which products are shown, leading to higher levels of customer satisfaction as well as higher levels of sales, revenues and profits.

### BRIEF DESCRIPTION OF INVENTION

1. Game

First aspect of the present invention provides a method for rendering the steps of a sales process into a game. This game framework provides salesperson(s) motivation, feedback, satisfaction and engagement, all incentives to use the invention. Game also organizes the delivery of recommendations, coaching instructions, media resources and supplementary information resources to the point of decision where they can have the greatest impact on shopper satisfaction and enterprise performance.

2. Customer Identification

Second aspect of the present invention is a method for associating customers' in-store emotions and actions with shopper identification and loyalty card data. In the event customer declines to self-identify at the beginning of the shopping journey, customer's in-store behavior can be associated if and when she checks out.

3. Coaching

Third aspect of the present invention is the provision of coaching resources driven by a Learning Machine, delivered to the salesperson(s) at the point in the sales process where they will be most useful. Coaching consists of reminders, exemplary phrases to help the salesperson(s) execute the steps, recommended products to show, and product resources such as value drivers, images, videos, graphics, ensembles use cases, instructions, terms and conditions and product availability.

Coaching instructions enable salesperson(s) to enhance the customer's experience, improve customers' understanding and customers' appreciation of the products on offer, and increase the likelihood of profitable purchases.

Provision of coaching instructions enable the enterprise to influence individual sales activities as they are occurring, improving both customer service quality, and transaction profitability.

Sales Manager Coaching can now be based on activity tracking (see below), so managers see salesperson(s)' activity levels and comparative conversion ratios to better find how to improve sales effectiveness.

4. Activity Tracking and Reporting

Fourth aspect of Invention is a system for activity tracking that enables the salesperson(s) to view on their Mobile Device a gamified rendition of their completions and achievements compared with the performance of their peers, plus review value of points and rewards earned for the day.

In addition to individual self-reporting, Activity Tracking aggregates performance data for the manager to view on her mobile device including real-time current status and number of times each individual on the team has completed each activity. Inherent graphs and graphics enable sales manager to drill down into the data, comparing salesperson(s) activity levels, and assessing performance levels.

Activity Tracking aggregates performance data for the entire management chain to view, including real time current status, performance and effectiveness of individuals, teams, regions, locations, and departments.

5. Product Recommendations

Invention replaces product search with product recommendations based on shopper input, background, purchase habits, spend profile, enterprise sourcing relationships, and up-to-the-minute enterprise commercial priorities.

6. Collecting a New Data Stream

Invention enables collection of entirely new forms of customer intelligence data relating to salesperson(s) activities, shopper preferences, shopper emotions, and shopper interests prior to making a product selection.

7. Always Listening

Invention features a microphone always listening to the surrounding conversation for key words or phrases which can be parsed and utilized to direct or personalize the shopping experience. In many cases, this eliminates the requirement for the sales person to tap an icon in order to record completion of an event, or direct invention to perform an action. It also enables Invention to sense the current activity, which enables monitoring of activities and also placing requests in their context.

System Overview

The embodiments described herein describe a mobile-accessed sales accelerator to be implemented on a touch-screen enabled mobile computing device which allows for dynamic real-time exchange of information between salesperson(s) serving a customer, a sales manager and higher levels of management monitoring, resourcing, coaching and directing activities, and a server providing coaching, data, illustrations, images, promotional videos, customer spend profile, current interest and prior purchase information. Information such as spend profile as well as data- and analytics-based coaching are provided at the moment they are needed to enable salesperson(s) to more personally serve the customer, upsell the products, and offer additional products as well as alternatives. The server accesses numerous Data Stores and external systems, and also manages sessions, security, salesperson(s) access, sales manager access and aggregation of data for merchandising, purchasing, marketing and product management.

In the exemplary embodiment described herein, either an Android™ or IOS™ tablet or Android™ or IOS™ smart phone may be used provided it includes a camera, microphone, touch screen, and WiFi or equivalent connectivity. Such access to a network is required. Ability to read barcodes and magnetic stripe and chip-enabled credit cards via third-party app such as PayPal, Stripe, Relay, Visa, Apple Pay, Google Pay or Square are highly recommended.

### DETAILED DESCRIPTION OF INVENTION

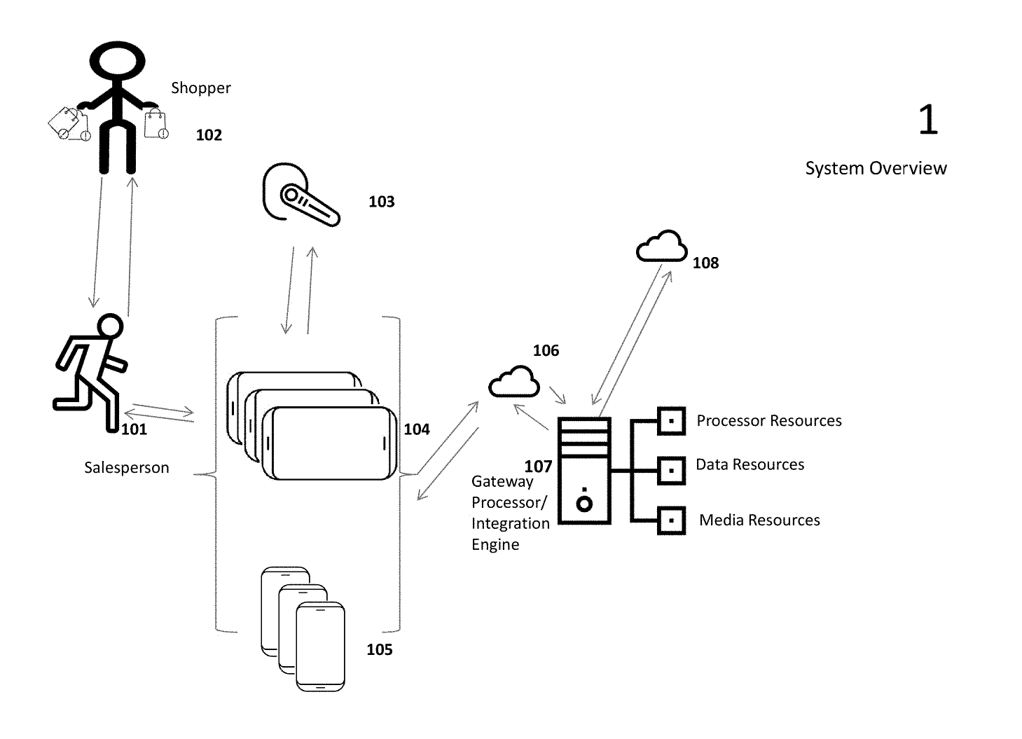

As generally shown in FIG. 1, a preferred embodiment consists of a salesperson(s) 101 serving a shopper 102, sales person equipped with a mobile tablet (IOS, Android or other) 104 or smart phone 105 potentially equipped with screen, barcode and/or RFID reader, and private audio interface 103 such as Bluetooth or wired earpiece, headset or earbuds always listening, able to recognize, capture and respond to environmental input spoken, typed, barcoded, radio-signal or neural input as enabled by the technology. Communications interface 106 connects user to various processing, data and media resources as exemplified in 109-112. Gateway processor 107 receives input from the mobile device, determines whether it is recognized, and executes commands, recording activity initiation and completion, and determining what data, or media resources to retrieve for display.

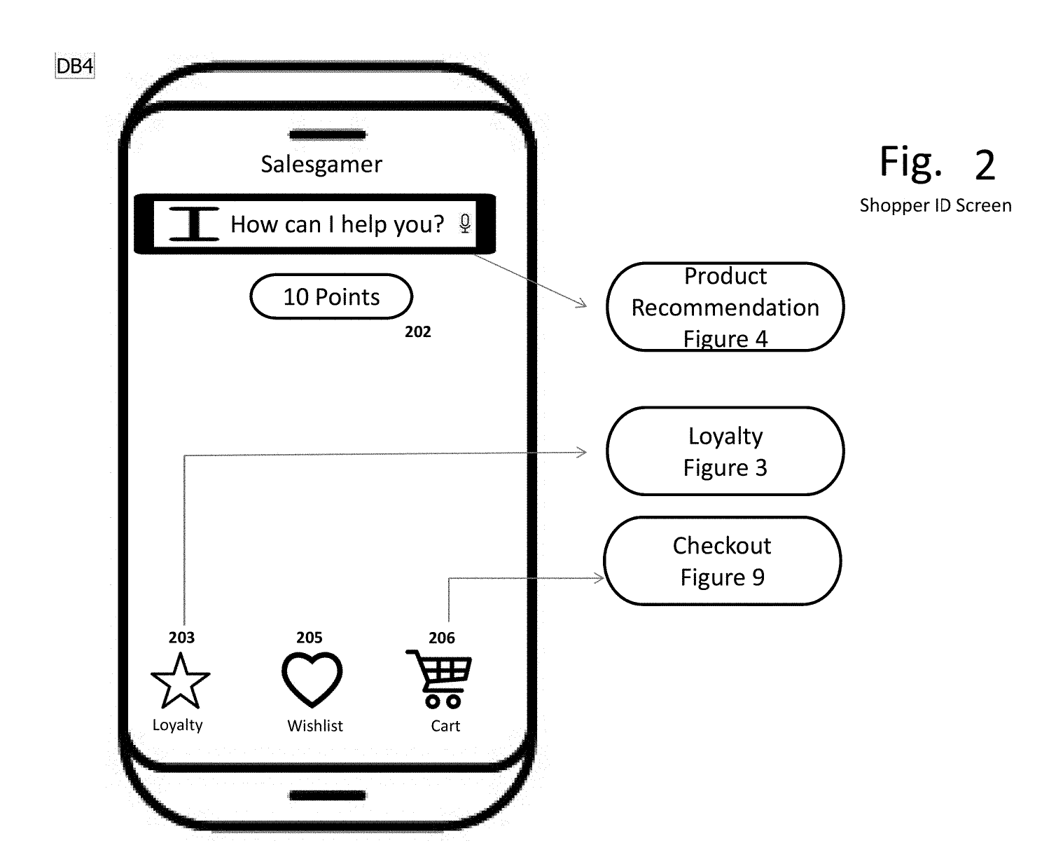

One feature of Invention is the ability to name, track, monitor and support the steps of a process as exemplified in FIG. 2. In this example, the steps are 203 ask about loyalty program membership, solicit interest indicator 204, add to wish list 205, and checkout 206. Upon completion of any step, points are awarded and displayed 202. For each step, system may provide supporting data, coaching or media resources appropriate to the shopper's interests, spend profile, as well as corporate strategies and product availability.

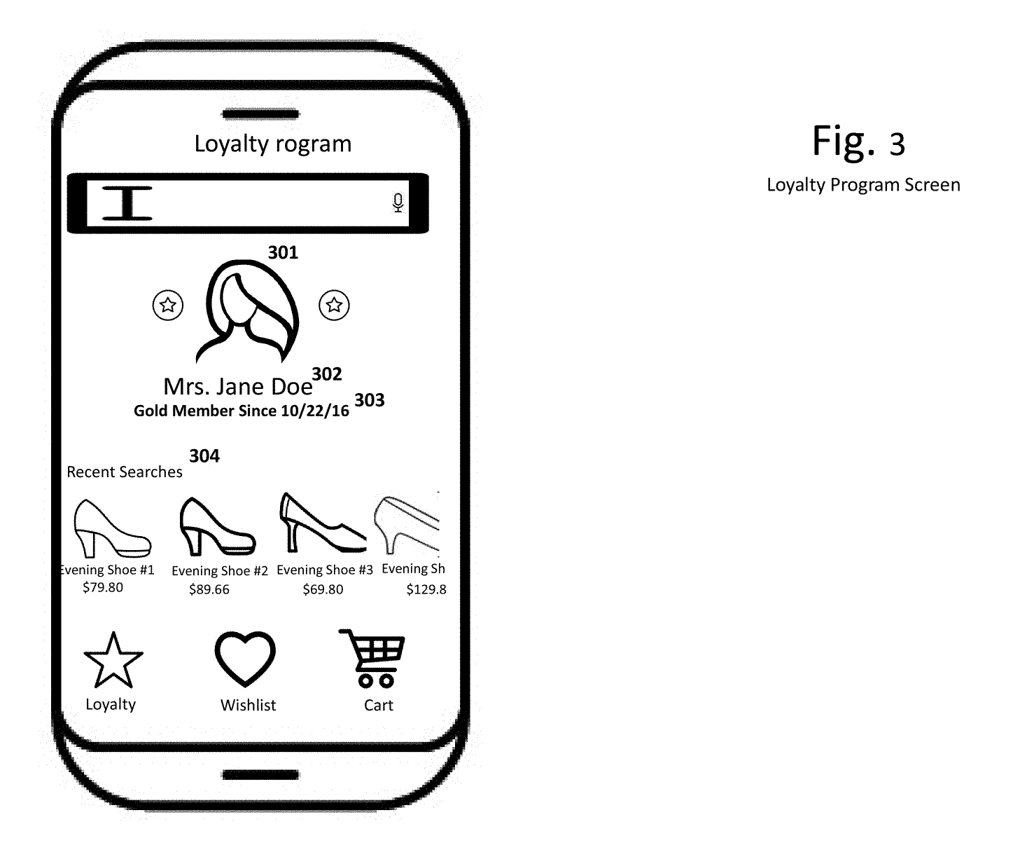

Invention provides access to as rich a store of shopper data as the enterprise makes available, as exemplified in FIG. 3. In the example, shopper has been identified by name 302, and a picture has been provided 301. Shopper has been identified as a Gold Member 303, and her most recent searches 304. These are data values that enterprise has decided to make available to salesperson(s) to facilitate personalization and appropriate services and product selection. In this example, manager has been notified that a gold shopper has entered the store.

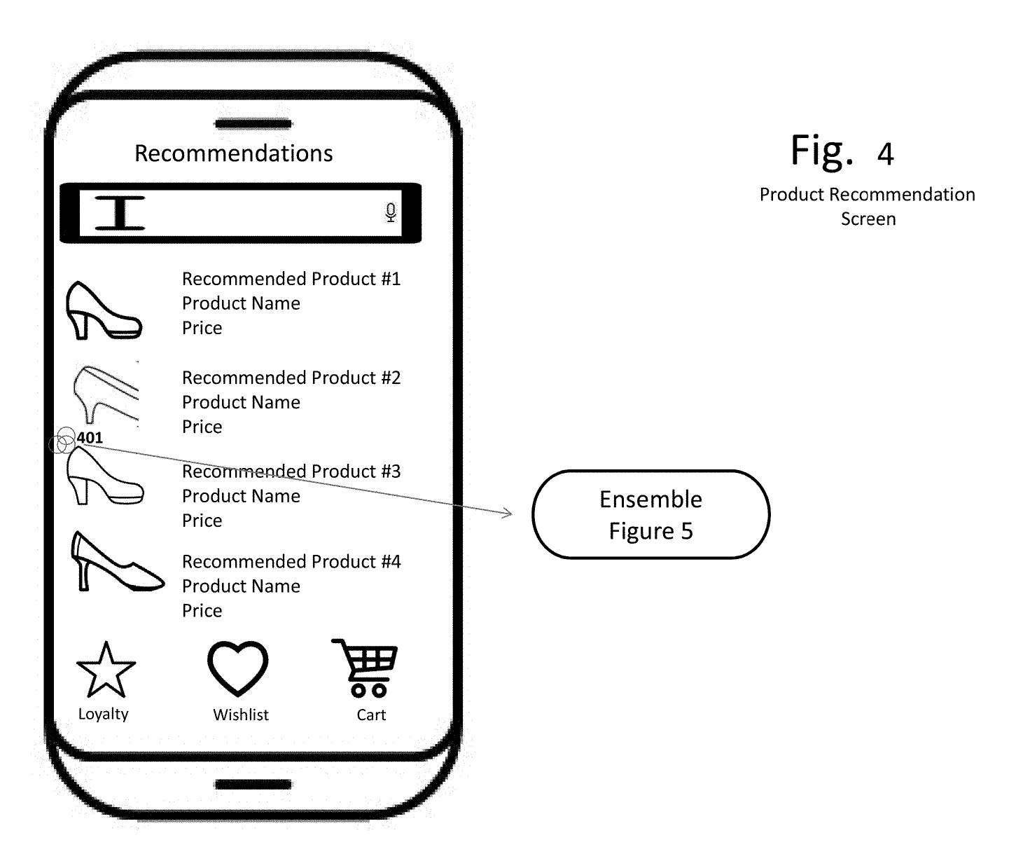

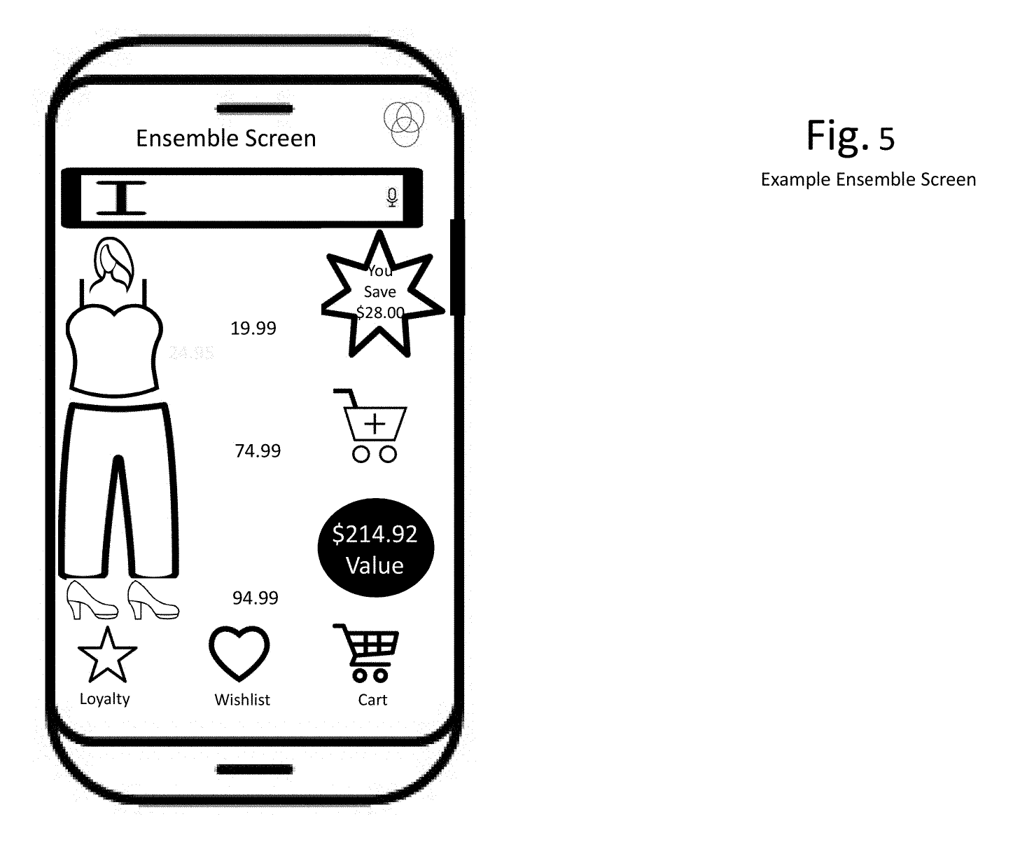

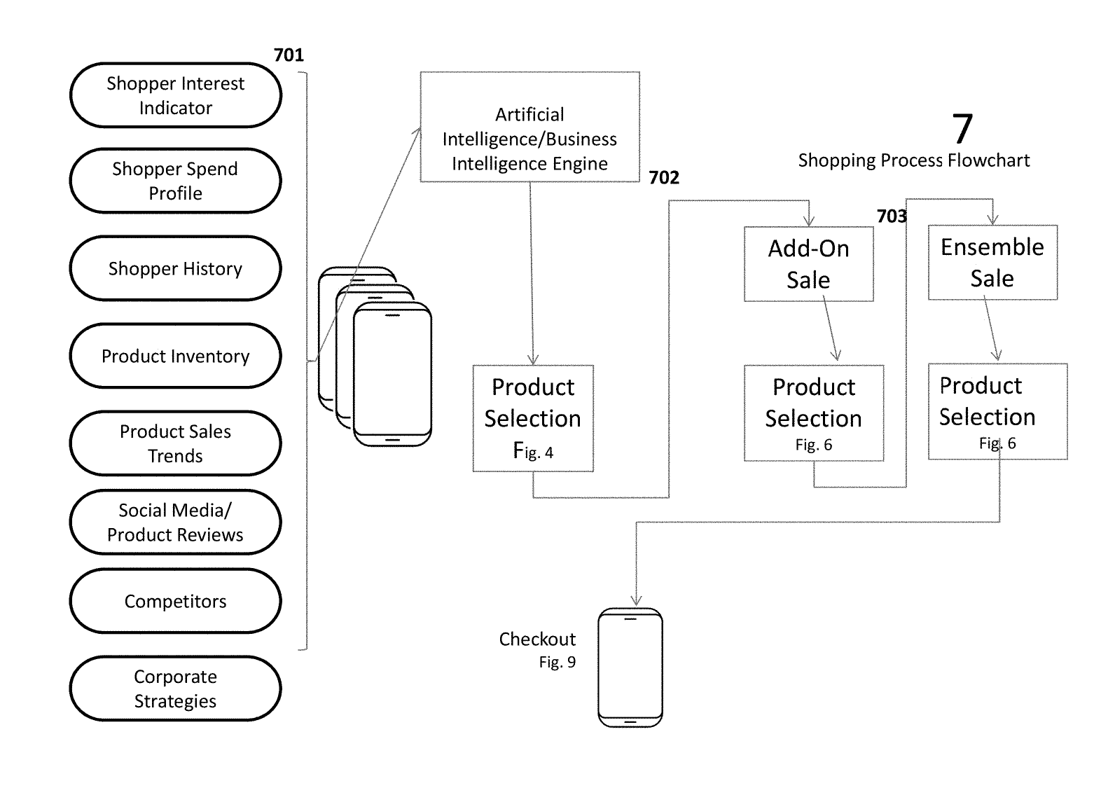

Invention selects which products to offer the instant shopper and the order in which to present them as exemplified in FIG. 4. The selection criteria are conditioned on the data resources and the strategic considerations of the enterprise as exemplified in FIG. 7 701. One feature of Invention is the ability to recognize which products are part of an outfit, kit or ensemble and to designate such products with an icon 401. When user taps the icon, FIG. 5 is displayed.

FIG. 5 illustrates an example of an ensemble selected according to what is known about shopper's history, preferences, prior interests, as known by the enterprise. Ensembles are pre-selected combinations of products offered for purchase as a single item, often with special pricing.

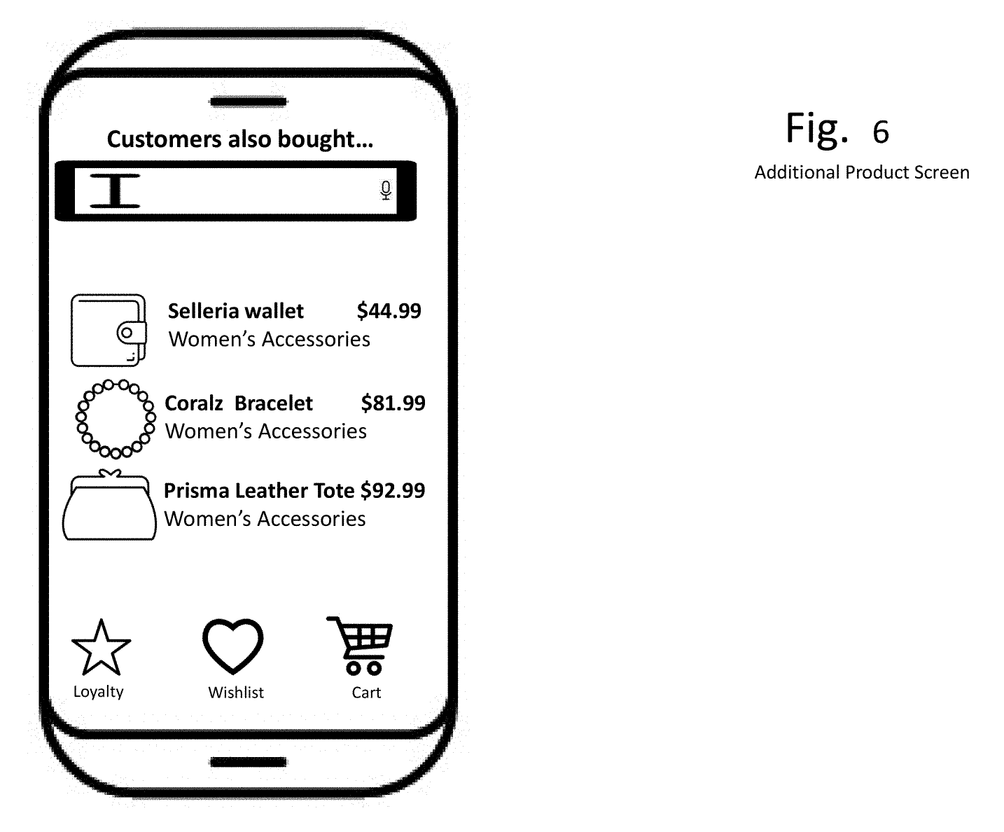

In the exemplified preferred embodiment, once a shopper has made an initial selection, additional products are offered for shopper consideration, as illustrated in FIG. 6.

1. Method for organizing the actions of a retail salesperson(s):
a. Enabling any retail orgainization, department or business unit to define its own step by step processes for salesperson(s) to execute to insure that shoppers have the best possible experience by provisioning salesperson(s) to offer personalized services and product recommendations, and
b. Defining each step as an action salesperson(s) is to perform, and
c. Automatically providing coaching, product selections, and media resources appropriate to the instant step of the process being executed.
d. Detecting each activity completion by salesperson(s) tapping an icon, or by invention recognizing key words or phrases in the audio environment, or by salesperson(s) speaking a keyword or invention completing an action.
e. Awarding the salesperson(s) recognition, points and rewards for completing each step, regardless of whether a sale was ultimately completed, and
f. Recognizing each activity completion by immediately messaging the salesperson(s) of her award of points, and
g. Updating displays available to salesperson(s) in real time showing her levels of performance and accumulation of points in comparison with those of her peers, and
h. Notifying managers of their workers' completions and point scores in real time as they occur.
i. Notifying salesperson(s) of their own and their peers' achievements in real times as they occur, and
j. Updating displays available to managers on their mobile devices and on their desktop computers in real time as they occur, such displays showing each worker's activity completions and conversion ratios, and
k. Making salesperson(s) aware of and enabling them to congratulate peers' achievements.

2. Method of claim 1 whereby new games can be defined by any authorized persons within the enterprise or its service organizations, and

[symbol]

3. Method of claim 1 whereby new games can be entered into the computer system by web-enabled personal computer via a browser or mobile interface, and

4. Method of claim 1 whereby invention records completion of a step of the game by salesperson(s) tapping an icon on their mobile device, or device, listening to words spoken detects activity completion, and

5. Method of claim 1 whereby the processor records completion of a step of the game by its own completion of an activity, such as delivery of media and/or information resources.

6. Method of claim 1 whereby notifications of activity completions are transmitted to a central server and stored on a designated Data Store, and

7. Method of claim 1 whereby salesperson(s) are instantly rewarded and recognized for their individual completions and achievements, and

8. Method of claim 1 whereby salesperson(s) are instantly rewarded and recognized for their cumulative achievements.

9. Method of claim 1 whereby the central server sends to salesperson(s) and managers notifications of thresholds achieved and completions accomplished by other members of the team, and

10. Method of claim 1 whereby process definition may include not just steps of the sales cycle, but other enterprise objectives such as training completion, collaboration events, educational attainment, or telephone or email outreach.

11. Method of claim 1 whereby the list of games, or steps within a game, available to any salesperson(s) may be conditioned by time of day, day of week, month, season, department, experience level, all at the discretion of the management.

12. Method of claim 1 whereby an individual's score is represented as a motion video, with different avatars, each representing a peer, moving towards an endpoint, their score represented as comparative degrees of progress towards the end.

13. Method of claim 1 whereby each individual's score is shown in juxtaposition with scores of her peers, enabling facile comparison and fostering competition to gain the highest score.

14. Method for operating a mobile sales accelerator:
a) provisioning salesperson(s) with a touch screen-enabled mobile computing device, and
b) optionally, provisioning salesperson(s) with Bluetooth (or other communication protocol)-enabled neural interface device which communicates with the mobile device, and
c) optionally, provisioning salesperson(s) with Bluetooth (or other communication protocol)-enabled audio device which communicates with the mobile device, and having Bluetooth (or other communication protocol) enabled devices always listening for pre-programmed words or phrases, and
d) connecting mobile device to system server via Wi-Fi™ or other communication protocol, and connecting server to other computing devices and data stores to enable server to execute commands, perform tasks (such as checkout) and retrieve data and media resources.

15. Method of claim 14 where the touch screen-enabled mobile computing device is a smart phone or a tablet.

16. Method of claim 14 where the neural communication device is a headset or other non-invasive neural interface device.

17. Method of claim 14 where the audio device is an audio headset or earpiece or ear buds and microphone attached by wire or wirelessly with a near-field communication protocol as exemplified by Bluetooth.

18. Method of claim 14 where the server is a computer as will be recognized by those having ordinary skill in the art with modifications, applications and embodiments to enable it to parse a stream of speech, recognize words and phrases, process requests and communicate with other computers to direct performance of programmed tasks, update databases, and retrieve data and media resources.

19. Method of capturing shopper activity data:
a) provisioning retail salesperson(s) with mobile, touch-screen-enabled computing devices, and
b) promulgating at least one standard process for the salesperson(s) to follow, and
c) enabling salesperson(s) to identify individual shoppers at the beginning of their shopping journey so their actions, emotions, interests and purchases can be associated with their individual records during the journey, or in the event shoppers do not self-identify at the beginning of their shopping journey, associating their actions, emotions, interests and purchases with their individual records at the end of their shopping journey when they checkout, and motivating the salesperson(s) to comply with the process by providing media images, motivational messages and recommendations as appropriate to each step of the process, and enabling salesperson(s) to record shoppers' emotions, interests and purchases with a single tap on the mobile device, or enabling device to record shoppers' emotions, interests, interest-indications and selections by listening to the conversation and capturing incidence of keywords, parsable phrases or other recognizable elements of conversation, and providing managers with a graphical and numeric screen showing individuals' activity completions and conversion ratios so they can monitor and encourage executing steps of the process and reporting of shoppers' emotions, interests and purchases, and providing salesperson(s) with instantaneous rewards and recognition for each completion of an action that records shoppers' emotions, interests and purchases.

20. Method of claim 18 wherein shoppers' actions, emotions, interests, rejections and purchases are captured by salesperson(s) in real-time on their mobile devices.

21. Method of claim 18 wherein records of shoppers' actions, emotions, interests, rejections and purchases are stored in a Data Store.

22. Method of claim 18 wherein the records of shoppers' actions, emotions, interests and purchases are associated with individual products and product categories when appropriate, and

23. Method of claim 18 wherein the records of shoppers' actions, emotions, interests, rejections, and purchases are correlated in an offline process to enable invention to make product recommendations with an elevated probability of appealing to the instant shopper.
